(19) United States
(12) Patent Application Publication
(10) Pub. No.: US 2012/0072122 A1
(43) Pub. Date: Mar. 22, 2012

(54) Forensic Integrated Search Technology

(75) Inventors: Robert Schweitzer, Pittsburgh, PA (US); Patrick J. Treado, Pittsburgh, PA (US); Jason Neiss, Pittsburgh, PA (US)

(73) Assignee: Chemimage Corporation, Pittsburgh, PA (US)

(21) Appl. No.: 13/246,906

(22) Filed: Sep. 28, 2011

Related U.S. Application Data
(63) Continuation of application No. 11/450,138, filed on Jun. 9, 2006, now abandoned.
(60) Provisional application No. 60/688,812, filed on Jun. 9, 2005.
(60) Provisional application No. 60/711,593, filed on Aug. 26, 2005.

(51) Int. Cl. G06F 19/00

(52) U.S. Cl. 702/19

(57) ABSTRACT

A system and method to search spectral databases and to identify unknown materials. A library comprising sublibraries is provided, each sublibrary containing a plurality of reference data sets corresponding to known materials. Test data sets are provided, characteristic of an unknown material. Each test data set is generated by one or more spectroscopic data generating instruments. Each sublibrary is searched and a corresponding set of scores is produced, indicating a likelihood of a match. Relative probability values are calculated for each searched sublibrary. All relative probability values are fused producing a set of final probability values, used to determine whether the unknown material is represented through a known material in the library. A highest final probability value is selected compared to a minimum confidence value. If the probability value is greater than or equal to the minimum confidence value, the known material is reported.

### RELATED APPLICATIONS

This application claims the benefit of U.S. Patent Application No. 60/688,812 filed Jun. 9, 2005 entitled Forensic Integrated Search Technology and U.S. Patent Application No. 60/711,593 filed Aug. 26, 2005 entitled Forensic Integrated Search Technology.

### FIELD OF DISCLOSURE

This application relates generally to systems and methods for searching spectral data bases and identifying unknown materials.

### BACKGROUND

The challenge of integrating multiple data types into a comprehensive database searching algorithm has yet to be adequately solved. Existing data fusion and database searching algorithms used in the spectroscopic community suffer from key disadvantages. Most notably, competing methods such as interactive searching are not scalable, and are at best semi-automated, requiring significant user interaction. For instance, the BioRAD KnowItAll® software claims an interactive searching approach that supports searching up to three different types of spectral data using the search strategy most appropriate to each data type. Results are displayed in a scatter plot format, requiring visual interpretation and restricting the scalability of the technique. Also, this method does not account for mixture component searches. Data Fusion Then Search (DFTS) is an automated approach that combines the data from all sources into a derived feature vector and then performs a search on that combined data. The data is typically transformed using a multivariate data reduction technique, such as Principal Component Analysis, to eliminate redundancy across data and to accentuate the meaningful features. This technique is also susceptible to poor results for mixtures, and it has limited capacity for user control of weighting factors.

The present disclosure describes a system and method that overcomes these disadvantages allowing users to identify unknown materials with multiple spectroscopic data.

### SUMMARY

The present disclosure provides for a system and method to search spectral databases and to identify unknown materials. A library having a plurality of sublibraries is provided wherein each sublibrary contains a plurality of reference data sets generated by a corresponding one of a plurality of spectroscopic data generating instruments associated with the sublibrary. Each reference data set characterizes a corresponding known material. A plurality of test data sets is provided that is characteristic of an unknown material, wherein each test data set is generated by one or more of the plurality of spectroscopic data generating instruments. For each test data set, each sublibrary is searched where the sublibrary is associated with the spectroscopic data generating instrument used to generate the test data set. A corresponding set of scores for each searched sublibrary is produced, wherein each score in the set of scores indicates a likelihood of a match between one of the plurality of reference data sets in the searched sublibrary and the test data set. A set of relative probability values is calculated for each searched sublibrary based on the set of scores for each searched sublibrary. All relative probability values for each searched sublibrary are fused producing a set of final probability values that are used in determining whether the unknown material is represented through a known material characterized in the library. A highest final probability value is selected from the set of final probability values and compared to a minimum confidence value. The known material represented in the libraries having the highest final probability value is reported, if the highest final probability value is greater than or equal to the minimum confidence value.

In one embodiment, the spectroscopic data generating instrument comprises one or more of the following: a Raman spectrometer; a mid-infrared spectrometer; an x-ray diffractometer; an energy dispersive x-ray analyzer; and a mass spectrometer. The reference data set comprises one or more of the following a Raman spectrum, a mid-infrared spectrum, an x-ray diffraction pattern, an energy dispersive x-ray spectrum, and a mass spectrum. The test data set comprises one or more of the following a Raman spectrum characteristic of the unknown material, a mid-infrared spectrum characteristic of the unknown material, an x-ray diffraction pattern characteristic of the unknown material, an energy dispersive x-ray spectrum characteristic of the unknown material, and a mass spectrum characteristic of the unknown material.

In another embodiment, each sublibrary is searched using a text query of the unknown material that compares the text query to a text description of the known material.

In yet another embodiment, the plurality of sublibraries are searched using a similarity metric comprising one or more of the following: an Euclidean distance metric, a spectral angle mapper metric, a spectral information divergence metric, and a Mahalanobis distance metric.

In still another embodiment, an image sublibrary is provided where the library contains a plurality of reference images generated by an image generating instrument associated with the image sublibrary. A test image characterizing an unknown material is obtained, wherein the test image data set is generated by the image generating instrument. The test image is compared to the plurality of reference images.

In another embodiment, the present disclosure provides further for a system and method to search spectra databases and to identify unknown materials. A library having a plurality of sublibraries is provided. Each sublibrary contains a plurality of reference data sets generated by a corresponding one of a plurality of spectroscopic data generating instruments associated with the sublibrary. Each reference data set characterizes a corresponding known material and one sublibrary comprises an image sublibrary containing a set of reference feature data. Each set of reference feature data includes one or more of the following: particle size, color value, and morphology data. A plurality of test data sets characteristic of an unknown material is obtained, wherein each test data set is generated by one of the plurality of spectroscopic data generating instruments and one test data set comprises an image test data set generated by an image generating instrument. A set of test feature data is extracted from the image test data set, using a feature extraction algorithm, the test feature data comprising one or more of the following: particle size, color value, and morphology. For the test feature data, the image sublibrary is searched to compare each set of reference feature data with said set of test feature data to thereby produce a set of scores, wherein each score in said set of scores indicates a likelihood of a match between a corresponding set of reference feature data in said searched image sublibrary and said set of test feature data. For each test data set, each sublibrary associated with the spectroscopic data generating instrument used to generate the test data set, is searched producing a corresponding set of scores for each searched sublibrary, wherein each score in said set of scores indicates a likelihood of a match between a corresponding one of said plurality of reference data sets in the searched sublibrary and the test data set. A set of relative probability values for each searched sublibrary is calculated based on the corresponding set of scores for each searched sublibrary and a set of relative probability values for the image sublibrary based on the corresponding set of scores for the image sublibrary. All relative probability values for each searched sublibrary and search image sublibrary are fused producing a set of final probability values to be used in determining whether said unknown material is represented through a corresponding known material characterized in the library. The known material represented in the library having the highest final probability value is reported, if the highest final probability value is greater than or equal to the minimum confidence value.

In another embodiment, if a highest final probability value is less than a minimum confidence value, the unknown material is treated as a mixture of unknown materials. A plurality of second test data sets is obtained that are characteristic of the unknown materials. Each second test data set is generated by one of the plurality of the different spectroscopic data generating instruments. The plurality of second test data sets is combined with the plurality test data sets to generate a plurality of combined test data sets. The combination is made such that the plurality of second test data sets and plurality of test data sets were generated by the same spectroscopic data generating instrument. For each combined test data set, each sublibrary, associated with the spectroscopic data generating instrument used to generate the combined test data set, is searched producing a corresponding second set of scores for each second searched sublibrary. Each second score in the second set of scores indicates a second likelihood of a match between a corresponding one of the plurality of reference data sets in the second searched sublibrary and each combined test data set. A second set of relative probability values is calculated for each searched sublibrary based on the corresponding second set of scores for each searched sublibrary. All second relative probability values, for each searched sublibrary, are fused producing a second set of final probability values to be used in determining whether the unknown material is represented through a corresponding set of known materials in the library.

### BRIEF DESCRIPTION OF THE DRAWINGS

The accompanying drawings, which are included to provide further understanding of the disclosure and are incorporated in and constitute a part of this specification, illustrate embodiments of the disclosure and, together with the description, serve to explain the principles of the disclosure.

In the drawings:

FIG. 1 illustrates a system of the present disclosure;

FIG. 2 illustrates a method of the present disclosure;

FIG. 3 illustrates a method of the present disclosure; and

FIG. 4 illustrates a method of the present disclosure.

### DESCRIPTION OF THE EMBODIMENTS

Reference will now be made in detail to the embodiments of the present disclosure, examples of which are illustrated in the accompanying drawings. Wherever possible, the same reference numbers will be used throughout the drawings to refer to the same or like parts.

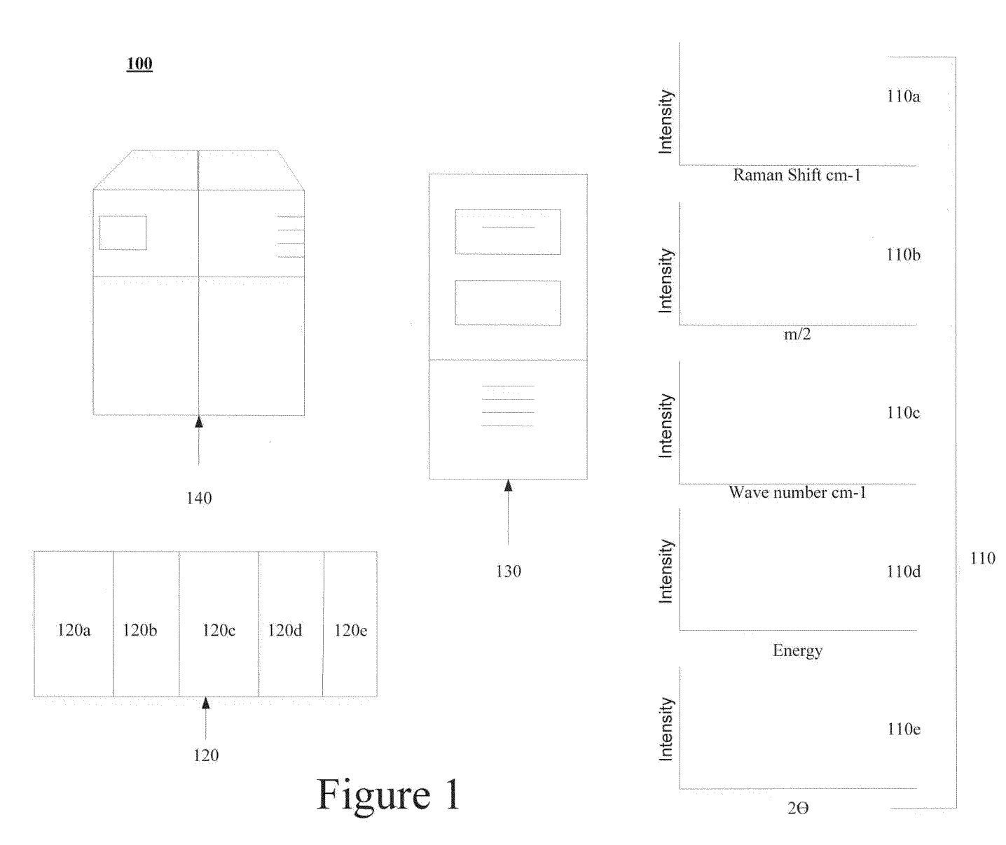

FIG. 1 illustrates an exemplary system 100 which may be used to carry out the methods of the present disclosure. System 1 includes a plurality of test data sets 110, a library 120, at least one processor 130 and a plurality of spectroscopic data generating instruments 140. The plurality of test data sets 110 include data that are characteristic of an unknown material. The composition of the unknown material includes a single chemical composition or a mixture of chemical compositions.

The plurality of test data sets 110 include data that characterizes an unknown material. The plurality of test data sets 110 are obtained from a variety of instruments 140 that produce data representative of the chemical and physical properties of the unknown material. The plurality of test data sets includes spectroscopic data, text descriptions, chemical and physical property data, and chromatographic data. In one embodiment, the test data set includes a spectrum or a pattern that characterizes the chemical composition, molecular composition, physical properties and/or elemental composition of an unknown material. In another embodiment, the plurality of test data sets include one or more of a Raman spectrum, a mid-infrared spectrum, an x-ray diffraction pattern, an energy dispersive x-ray spectrum, and a mass spectrum that are characteristic of the unknown material. In yet another embodiment, the plurality of test data sets may also include image data set of the unknown material. In still another embodiment, the test data set may include a physical property test data set selected from the group consisting of boiling point, melting point, density, freezing point, solubility, refractive index, specific gravity or molecular weight of the unknown material. In another embodiment, the test data set includes a textual description of the unknown material.

The plurality of spectroscopic data generating instruments 140 include any analytical instrument which generates a spectrum, an image, a chromatogram, a physical measurement and a pattern characteristic of the physical properties, the chemical composition, or structural composition of a material. In one embodiment, the plurality of spectroscopic data generating instruments 140 includes a Raman spectrometer, a mid-infrared spectrometer, an x-ray diffractometer, an energy dispersive x-ray analyzer and a mass spectrometer. In another embodiment, the plurality of spectroscopic data generating instruments 140 further includes a microscope or image generating instrument. In yet another embodiment, the plurality of spectroscopic generating instruments 140 further includes a chromatographic analyzer.

Library 120 includes a plurality of sublibraries 120a, 120b, 120c, 120d and 120e. Each sublibrary is associated with a different spectroscopic data generating instrument 140. In one embodiment, the sublibraries include a Raman sublibrary, a mid-infrared sublibrary, an x-ray diffraction sublibrary, an energy dispersive sublibrary and a mass spectrum sublibrary. For this embodiment, the associated spectroscopic data generating instruments 140 include a Raman spectrometer, a mid-infrared spectrometer, an x-ray diffractometer, an energy dispersive x-ray analyzer and a mass spectrometer. In another embodiment, the sublibraries further include an image sublibrary associated with a microscope. In yet another embodiment, the further include a textual description sublibrary. In still yet another embodiment, the sublibraries further include a physical property sublibrary.

Each sublibrary contains a plurality of reference data sets. The plurality of reference data sets include data representative of the chemical and physical properties of a plurality of known materials. The plurality of reference data sets include spectroscopic data, text descriptions, chemical and physical property data, and chromatographic data. In one embodiment, a reference data set includes a spectrum and a pattern that characterizes the chemical composition, the molecular composition and/or element composition of a known material. In another embodiment, the reference data set includes a Raman spectrum, a mid-infrared spectrum, an x-ray diffraction pattern, an energy dispersive x-ray spectrum, and a mass spectrum of known materials. In yet another embodiment, the reference data set further includes a physical property test data set of known materials selected from the group consisting of boiling point, melting point, density, freezing point, solubility, refractive index, specific gravity or molecular weight. In still another embodiment, the reference data set further includes an image displaying the shape, size and morphology of known materials. In another embodiment, the reference data set includes feature data having information such as particle size, color and morphology of the known material.

System 100 further includes at least one processor 130 in communication with the library 120 and sublibraries. The processor 130 executes a set of instructions to identify the composition of an unknown material.

In one embodiment, system 100 includes a library 120 having the following sublibraries: a Raman sublibrary associated with a Raman spectrometer; an infrared sublibrary associated with an infrared spectrometer; an x-ray diffraction sublibrary associated with an x-ray diffractometer; an energy dispersive x-ray sublibrary associated with an energy dispersive x-ray spectrometer; and a mass spectrum sublibrary associated with a mass spectrometer. The Raman sublibrary contains a plurality of Raman spectra characteristic of a plurality of known materials. The infrared sublibrary contains a plurality of infrared spectra characteristic of a plurality of known materials. The x-ray diffraction sublibrary contains a plurality of x-ray diffraction patterns characteristic of a plurality of known materials. The energy dispersive sublibrary contains a plurality of energy dispersive spectra characteristic of a plurality of known materials. The mass spectrum sublibrary contains a plurality of mass spectra characteristic of a plurality of known materials. The test data sets include two or more of the following: a Raman spectrum of the unknown material, an infrared spectrum of the unknown material, an x-ray diffraction pattern of the unknown material, an energy dispersive spectrum of the unknown material, and a mass spectrum of the unknown material.

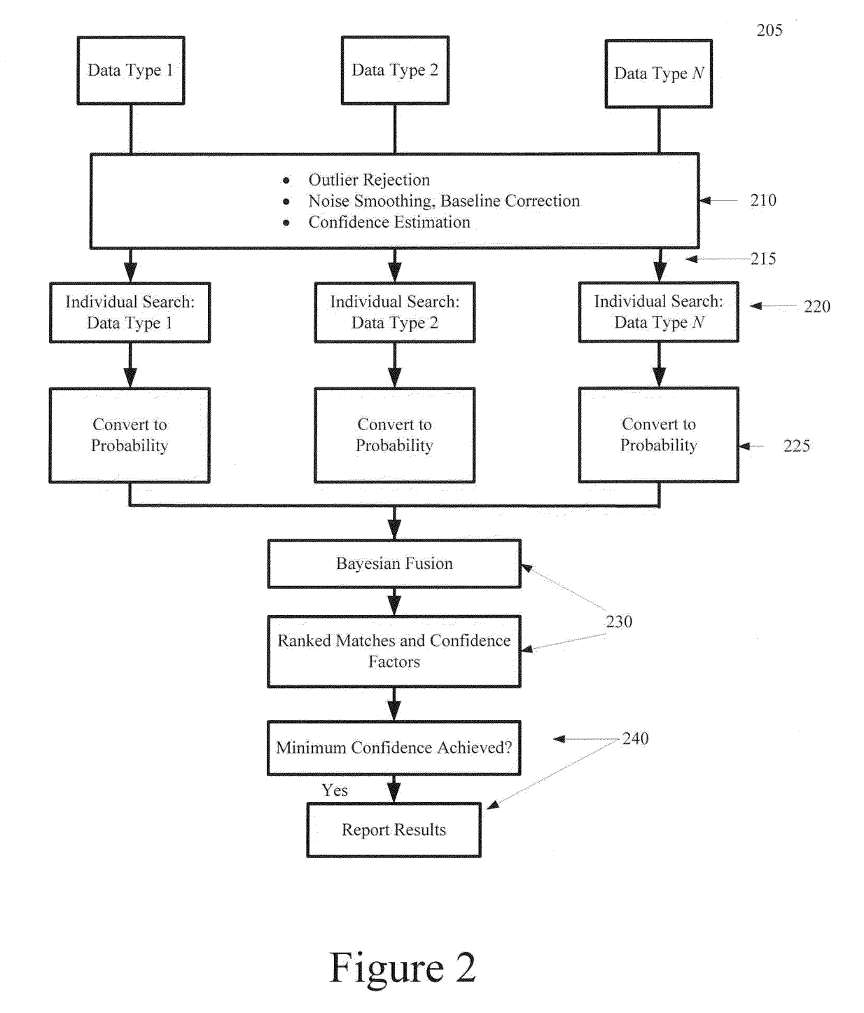

With reference to FIG. 2, a method of the present disclosure is illustrated to determine the identification of an unknown material. In step 205, a plurality of test data sets characteristic of an unknown material are obtained by at least one of the different spectroscopic data generating instruments. In one embodiment, the plurality of test data sets 110 are obtained from one or more of the different spectroscopic data generating instruments 140. When a single spectroscopic data generating instrument is used to generate the test data sets, at least two or more test data sets are required. In yet another embodiment, the plurality of test data sets 110 are obtained from at least two different spectroscopic data generating instruments.

In step 210, the test data sets are corrected to remove signals and information that are not due to the chemical composition of the unknown material. Algorithms known to those skilled in the art may be applied to the data sets to remove electronic noise and to correct the baseline of the test data set. The data sets may also be corrected to reject outlier data sets. In one embodiment, the system detects test data sets, having signals and information that are not due to the chemical composition of the unknown material. These signals and information are then removed from the test data sets. In another embodiment, the user is issued a warning when the system detects test data set having signals and information that are not due to the chemical composition of the unknown material.

With further reference to FIG. 2, each sublibrary is searched, in step 220. The searched sublibraries are those that are associated with the spectroscopic data generating instrument used to generate the test data sets. For example, when the plurality of test data sets includes a Raman spectrum of the unknown material and an infrared spectrum of the unknown material, the system searches the Raman sublibrary and the infrared sublibrary. The sublibrary search is performed using a similarity metric that compares the test data set to each of the reference data sets in each of the searched sublibraries. In one embodiment, any similarity metric that produces a likelihood score may be used to perform the search. In another embodiment, the similarity metric includes one or more of an Euclidean distance metric, a spectral angle mapper metric, a spectral information divergence metric, and a Mahalanobis distance metric. The search results produce a corresponding set of scores for each searched sublibrary. The set of scores contains a plurality of scores, one score for each reference data set in the searched sublibrary. Each score in the set of scores indicates a likelihood of a match between the test data set and each of reference data set in the searched sublibrary.

In step 225, the set of scores, produced in step 220, are converted to a set of relative probability values. The set of relative probability values contains a plurality of relative probability values, one relative probability value for each reference data set.

Referring still to FIG. 2, all relative probability values for each searched sublibrary are fused, in step 230, using the Bayes probability rule. The fusion produces a set of final probability values. The set of final probability values contains a plurality of final probability values, one for each known material in the library. The set of final probability values is used to determine whether the unknown material is represented by a known material in the library.

In step 240, the identity of the unknown material is reported. To determine the identity of the unknown, the highest final probability value from the set of final probability values is selected. This highest final probability value is then compared to a minimum confidence value. If the highest final probability value is greater than or equal to the minimum confidence value, the known material having the highest final probability value is reported. In one embodiment, the minimum confidence value may range from 0.70 to 0.95. In another embodiment, the minimum confidence value ranges from 0.8 to 0.95. In yet another embodiment, the minimum confidence value ranges from 0.90 to 0.95.

As described above, the library 120 contains several different types of sublibraries, each of which is associated with an analytical technique, i.e., the spectroscopic data generating instrument 140. Therefore, each analytical technique provides an independent contribution to identifying the unknown material. Additionally, each analytical technique has a different level of specificity for matching a test data set for an unknown material with a reference data set for a known material. For example, a Raman spectrum generally has higher discriminatory power than a fluorescence spectrum and is thus considered more specific for the identification of an unknown material. The greater discriminatory power of Raman spectroscopy manifests itself as a higher likelihood for matching any given spectrum using Raman spectroscopy than using fluorescence spectroscopy. The method illustrated in FIG. 2 accounts for this variability in discriminatory power in the set of scores for each spectroscopic data generating instrument. The set of scores act as implicit weighting factors that bias the scores according to the discriminatory of the instrument. While the set of scores act as implicit weighting factors, the method of the present disclosure also provides for using explicit weighting factor. In one embodiment the explicit weighting factor for each spectroscopic data generating instrument is the same. In another embodiment the weighting factors include {W}={W_{Raman}, W_{x-ray}, W_{MassSpec}, W_{IR}, and W_{ED}}.

In yet another embodiment, each spectroscopic data generating instrument has a different associated weighting factor. Estimates of these associated weighting factors are determined through automated simulations. In particular, with at least two data records for each spectroscopic data generating instrument (i.e. two Raman spectra per material), the library is split into training and validation sets. The training set is then used as the reference data set. The validation set is used as test data set and searched against the training set. Without the weighting factors ({W}={1, 1, . . . , 1}), a certain percentage of the validation set will be correctly identified, and some percentage will be incorrectly identified. By explicitly or randomly varying the weighting factors and recording each set of correct and incorrect identification rates, the optimal operating set of weighting factors, for each spectroscopic data generating instrument, is estimated by choosing those weighting factors that result in the best identification rates.

The method of the present disclosure also provides for using a text query to limit the number of reference data sets of known compounds in the sublibrary searched in step 220 of FIG. 2. The method illustrated in FIG. 2, would further include step 215, where each sublibrary is searched, using a text query. Each known material in the plurality of sublibraries includes a text description of a physical property or a distinguishing feature of the material. A text query, describing the unknown material is submitted. The plurality of sublibraries are searched by comparing the text query to a text description of each known materials. A match of the text query to the text description or no match of the text query to the text description is produced. The plurality of sublibraries are modified by removing the reference data sets that produced a no match answer. Therefore, the modified sublibraries have fewer reference data sets than the original sublibraries. For example, a text query for white powders eliminates the reference data sets from the sublibraries for any known compounds having a textual description of black powders. The modified sublibraries are then searched as described for steps 220-240 as illustrated in FIG. 2.

The method of the present disclosure also provides for using images to identify the unknown material. In one embodiment, an image test data set characterizing an unknown material is obtained from an image generating instrument. The test image, of the unknown, is compared to the plurality of reference images for the known materials in an image sublibrary to assist in the identification of the unknown material. In another embodiment, a set of test feature data is extracted from the image test data set using a feature extraction algorithm to generate test feature data. The selection of an extraction algorithm is well known to one of skill in the art of digital imaging. The test feature data includes information concerning particle size, color or morphology of the unknown material. The test feature data is searched against the reference feature data in the image sublibrary, producing a set of scores. The reference feature data includes information such as particle size, color and morphology of the material. The set of scores, from the image sublibrary, are used to calculate a set of probability values. The relative probability values, for the image sublibrary, are fused with the relative probability values for the other plurality of sublibraries as illustrated in FIG. 2, step 230, producing a set of final probability values. The known material represented in the library, having the highest final probability value is reported if the highest final probability value is greater than or equal to the minimum confidence value as in step 240 of FIG. 2.

The method of the present disclosure further provides for enabling a user to view one or more reference data set of the known material identified as representing the unknown material despite the absence of one or more test data sets. For example, the user inputs an infrared test data set and a Raman test data set to the system. The x-ray dispersive spectroscopy (“EDS”) sublibrary contains an EDS reference data set for the plurality of known compounds even though the user did not input an EDS test data set. Using the steps illustrated in FIG. 2, the system identifies a known material, characterized in the infrared and Raman sublibraries, as having the highest probability of matching the unknown material. The system then enables the user to view an EDS reference data set, from the EDS sublibrary, for the known material having the highest probability of matching the unknown material. In another embodiment, the system enables the user to view one or more EDS reference data sets for one or more known materials having a high probability of matching the unknown material.

The method of the present disclosure also provides for identifying unknowns when one or more of the sublibraries are missing one or more reference data sets. When a sublibrary has fewer reference data sets than the number of known materials characterized within the main library, the system treats this sublibrary as an incomplete sublibrary. To obtain a score for the missing reference data set, the system calculates a mean score based on the set of scores, from step 225, for the incomplete library. The mean score is then used, in the set of scores, as the score for missing reference data set.

The method of the present disclosure also provides for identifying miscalibrated test data sets. When one or more of the test data sets fail to match any reference data set in the searched sublibrary, the system treats the test data set as miscalibrated. The assumed miscalibrated test data sets are processed via a grid optimization process where a range of zero and first order corrections are applied to the data to generate one or more corrected test data sets. The system then reanalyzes the corrected test data set using the steps illustrated in FIG. 2. This same process may be applied during the development of the sublibraries to ensure that all the library spectra are properly calibrated. The sublibrary examination process identifies referenced data sets that do not have any close matches, by applying the steps illustrated in FIG. 2, to determine if changes in the calibration results in close matches.

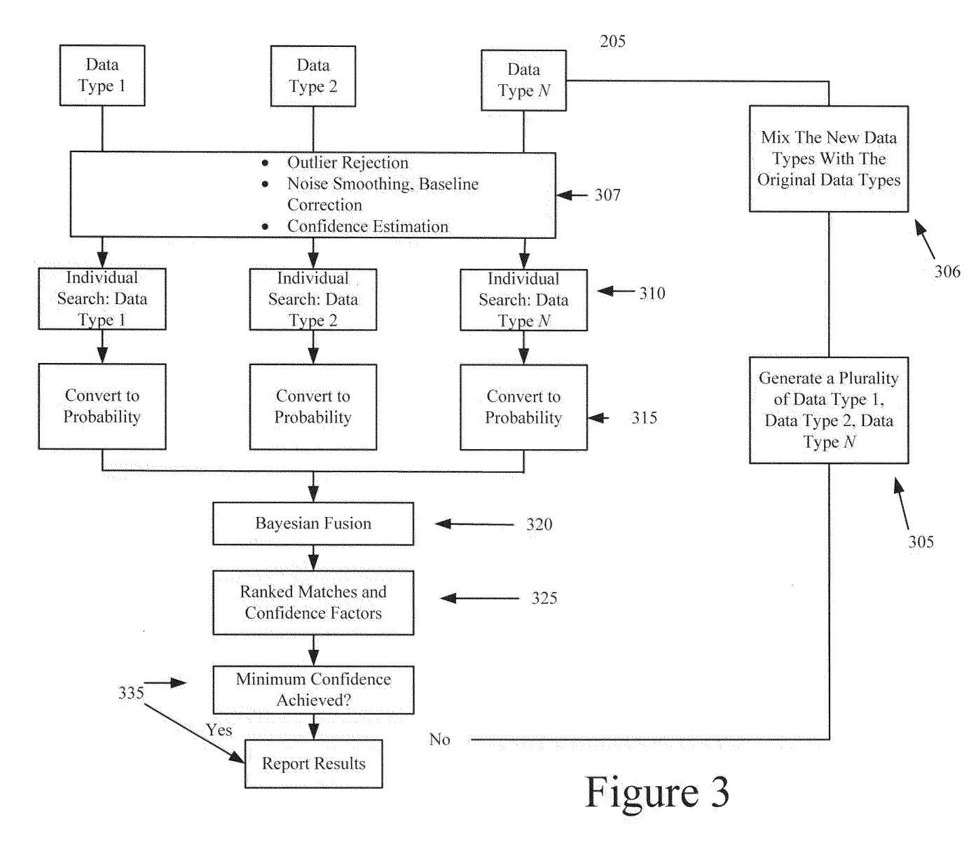

The method of the present disclosure also provides for the identification of the components of an unknown mixture. With reference to FIG. 2, if the highest final probability value is less than the minimum confidence value, in step 240, the system of the present disclosure treats the unknown as a mixture. Referring to FIG. 3, a plurality of new test data sets, characteristic of the unknown material, are obtained in step 305. Each new test data set is generated by one of the plurality of the different spectroscopic data generating instruments. For each different spectroscopic data generating instruments at least two new test data sets are obtained. In one embodiment, six to twelve new test data sets are obtained from a spectroscopic data generating instrument. The new test data sets are obtained from several different locations of the unknown. The new test data sets are combined with the test data sets, of step 205 in FIG. 2, to generate combined test data sets, of step 306 of FIG. 3. When the test data sets are combined with the new test data sets, the sets must be of the same type in that they are generated by the same spectroscopic data generating instrument. For example, new test data sets generated by a Raman spectrometer are combined with the initial test data sets also generated by a Raman spectrometer.

In step 307, the test data sets are corrected to remove signals and information that are not due to the chemical composition of the unknown material. In step 310, each sublibrary is searched for a match for each combined test data set. The searched sublibraries are associated with the spectroscopic data generating instrument used to generate the combined test data sets. The sublibrary search is performed using a spectral unmixing metric that compares the plurality of combined test data sets to each of the reference data sets in each of the searched sublibraries. A spectral unmixing metric is disclosed in U.S. patent application Ser. No. 10/812,233 entitled “Method for Identifying Components of a Mixture via Spectral Analysis,” filed Mar. 29, 2004 which is incorporated herein by reference in its entirety; however this application forms no part of the present invention. The sublibrary searching produces a corresponding second set of scores for each searched sublibrary. Each second score and the second set of scores is the score and set of scores produced in the second pass of the searching method. Each second score in said second set of scores indicates a second likelihood of a match between the combined test data sets and each of reference data sets in the searched sublibraries. The second set of scores contains a plurality of second scores, one second score for each reference data set in the searched sublibrary.

According to a spectral unmixing metric, the combined test data sets define an n-dimensional data space, where n is the number of points in the test data sets. Principal component analysis (PCA) techniques are applied to the n-dimensional data space to reduce the dimensionality of the data space. The dimensionality reduction step results in the selection of m eigenvectors as coordinate axes in the new data space. For each search sublibrary, the reference data sets are compared to the reduced dimensionality data space generated from the combined test data sets using target factor testing techniques. Each sublibrary reference data set is projected as a vector in the reduced m-dimensional data space. An angle between the sublibrary vector and the data space results from target factor testing. This is performed by calculating the angle between the sublibrary reference data set and the projected sublibrary data. These angles are used as the second scores which are converted to second probability values for each of the reference data sets and fed into the fusion algorithm in the second pass of the search method. This paragraph forms no part of the present invention.

Referring still to FIG. 3, second relative probability values are determined and the values are then fused. A second set of relative probability values are calculated for each searched sublibrary based on the corresponding second set of stores for each searched sublibrary, step 315. The second set of relative probability values is the set of probability values calculated in the second pass of the search method. The second relative probability values for each searched sublibrary are fused using the Bayers probability rule to produce a second set of final probability values, step 320. The set of final probability values are used in determining whether the unknown materials are represented by a set of known materials in the library.

From the set of second final probabilities values, a set of high second final probability values is selected. The set of high second final probability values is then compared to the minimum confidence value, step 325. If each high second final probability value is greater than or equal to the minimum confidence value, step 335, the set of known materials represented in the library having the high second final probability values is the reported. In one embodiment, the minimum confidence value may range from 0.70 to 0.95. In another embodiment, the minimum confidence value may range from 0.8 to 0.95. In yet another embodiment, the minimum confidence value may range from 0.9 to 0.95.

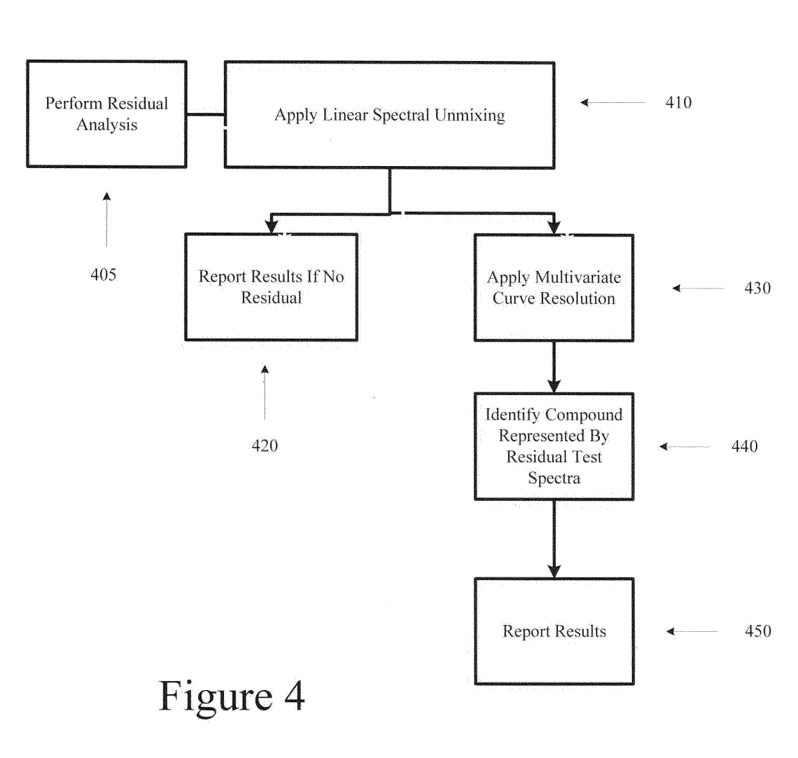

Referring to FIG. 4, a user may also perform a residual analysis. For each spectroscopic data generating instrument, residual data is defined by the following equation: COMBINED TEST DATA SET=CONCENTRATION×REFERENCE DATA SET+RESIDUAL To calculate a residual data set, a linear spectral unmixing algorithm may be applied to the plurality of combined test data sets, to thereby produce a plurality of residual test data, step 410. Each searched sublibrary has an associated residual test data. When a plurality of residual data are not identified in step 410, a report is issued, step 420. In this step, the components of the unknown material are reported as those components determined in step 335 of FIG. 3. Residual data is determined when there is a significant percentage of variance explained by the residual as compared to the percentage explained by the reference data set defined in the above equation. When residual test data is determined in step 410, a multivariate curve resolution algorithm is applied to the plurality of residual test data generating a plurality of residual data spectra, in step 430. Each searched sublibrary has a plurality of associated residual test spectra. In step 440, the identification of the compound corresponding to the plurality of residual test spectra is determined and reported in step 450. In one embodiment, the plurality of residual test spectra are compared to the reference data set in the sublibrary, associated with the residual test spectra, to determine the compound associated with the residual test spectra. If residual test spectra do not match any reference data sets in the plurality of sublibraries, a report is issued stating an unidentified residual compound is present in the unknown material.

### EXAMPLES

### Example 1

In this example, a network of n spectroscopic instruments each provide test data sets to a central processing unit. Each instrument makes an observation vector {Z} of parameter {X}. For instance, a dispersive Raman spectrum would be modeled with X=dispersive Raman and Z=the spectral data. Each instrument generates a test data set and calculates (using a similarity metric) the likelihoods {pᵢ(Hₐ)} of the test data set being of type Hₐ. Bayes' theorem gives:

$$p ( {H}_{a} \vert \{ Z \} ) = \frac{p ( \{ Z \} \vert {H}_{a} ) p ( {H}_{a} )}{p ( \{ Z \} )} \qquad ( Equation 1 )$$

where:
p(Hₐ|{Z}): the posterior probability of the test data being of type Hₐ, given the observations {Z};
p({Z}|Hₐ): the probability that observations {Z} were taken, given that the test data is type Hₐ;
p(Hₐ): the prior probability of type Hₐ being correct; and
p({Z}): a normalization factor to ensure the posterior probabilities sum to 1.
Assuming that each spectroscopic instrument is independent of the other spectroscopic instruments gives:

$$p ( \{ Z \} \vert {H}_{a} ) = {\prod }_{i = 1}^{n} {p}_{i} ( \{ {Z}_{i} \} \vert {H}_{a} ) \qquad ( Equation 2 )$$

and from Bayes rule

$$\begin{matrix}p ( \{ Z \} \vert {H}_{a} ) = {\prod }_{i = 1}^{n} ( {p}_{i} ( \{ {Z}_{i} \} \vert \{ X \} ) {p}_{i} ( \{ X \} \vert {H}_{a} ) \\ gives & ( Equation 3 ) \\ p ( {H}_{a} \vert \{ Z \} ) = α \cdot p ( {H}_{a} ) {\prod }_{i = 1}^{n} [ ( {p}_{i} ( \{ {Z}_{i} \} \vert \{ X \} ) {p}_{i} ( \{ X \} \vert {H}_{a} ) ] & ( Equation 4 )\end{matrix}$$

Equation 4 is the central equation that uses Bayesian data fusion to combine observations from different spectroscopic instruments to give probabilities of the presumed identities.

To infer a presumed identity from the above equation, a value of identity is assigned to the test data having the most probable (maximum a posteriori) result:

$${\hat{H}}_{a} = arg {max}_{a} p ( {H}_{a} \vert \{ Z \} ) \qquad ( Equation 5 )$$

To use the above formulation, the test data is converted to probabilities. In particular, the spectroscopic instrument must give p({Z}|Hₐ), the probability that observations {Z} were taken, given that the test data is type Hₐ. Each sublibrary is a set of reference data sets that match the test data set with certain probabilities. The probabilities of the unknown matching each of the reference data sets must sum to 1. The sublibrary is considered as a probability distribution.

The system applies a few commonly used similarity metrics consistent with the requirements of this algorithm: Euclidean Distance, the Spectral Angle Mapper (SAM), the Spectral Information Divergence (SID), Mahalanobis distance metric and spectral unmixing. The SID has roots in probability theory and is thus the best choice for the use in the data fusion algorithm, although either choice will be technically compatible. Euclidean Distance (“ED”) is used to give the distance between spectrum x and spectrum y:

$$E D ( x , y ) = \sqrt{{\sum }_{i = 1}^{L} {( {x}_{i} - {y}_{i} )}^{2}} \qquad ( Equation 6 )$$

Spectral Angle Mapper (“SAM”) finds the angle between spectrum x and spectrum y:

$$S A M ( x , y ) = {cos}^{- 1} ( \frac{{\sum }_{i = 1}^{L} {x}_{i} {y}_{i}}{\sqrt{{\sum }_{i = 1}^{L} {x}_{i}^{2}} \sqrt{{\sum }_{i = 1}^{L} {y}_{i}^{2}}} ) \qquad ( Equation 7 )$$

When SAM is small, it is nearly the same as ED. Spectral Information Divergence (“SID”) takes an information theory approach to similarity and transforms the x and y spectra into probability distributions p and q:

$$p = {[ {p}_{1} , {p}_{2} , … , {p}_{L} ]}^{T} , q = {[ {q}_{1} , {q}_{2} , … , {q}_{L} ]}^{T} \\ {p}_{i} = \frac{{x}_{i}}{{\sum }_{i = 1}^{L} {x}_{i}} , {q}_{i} = \frac{{y}_{i}}{{\sum }_{i = 1}^{L} {y}_{i}} \qquad ( Equation 8 )$$

The discrepancy in the self-information of each hand is defined as:

$${D}_{i} ( {x}_{i} \vert \vert {y}_{i} ) = log [ \frac{{p}_{i}}{{q}_{i}} ] \qquad ( Equation 9 )$$

So the average discrepancies of x compared to y and y compared to x (which are different) are:

$$D ( x \vert \vert y ) = {\sum }_{i = 1}^{L} {p}_{i} log [ \frac{{p}_{i}}{{q}_{i}} ] , D ( y \vert \vert x ) = {\sum }_{i = 1}^{L} {q}_{i} log [ \frac{{q}_{i}}{{p}_{i}} ] \qquad ( Equation 10 )$$

The SID is thus defined as:

SID(x,y)=D(x∥y)+D(y∥x) (Equation 11)

A measure of the probabilities of matching a test data set with each entry in the sublibrary is needed. Generalizing a similarity metric as m(x, y), the relative spectral discrimination probabilities is determined by comparing a test data set x against k library entries.

$${p}_{x , Library} ( k ) = 1 - \frac{m ( x , {y}_{k} )}{{\sum }_{i = 1}^{L} m ( x , {y}_{i} )} \qquad ( Equation 12 )$$

Equation 12 is used as p({Z}|Hₐ) for each sensor in the fusion formula.

Assuming, a library consists of three reference data sets: {H}={A, B, C}. Three spectroscopic instruments (each a different modality) are applied to this sample and compare the outputs of each spectroscopic instrument to the appropriate sublibraries (i.e. dispersive Raman spectrum compared with library of dispersive Raman spectra). If the individual search results, using SID, are:
SID(x_{Raman}, Library_{Raman})={20, 10, 25}
SID(x_{Fluor}, Library_{Fluor})={40, 35, 50}
SID(x_{IR}, Library_{IR})={50, 20, 40}
Applying Equation 12, the relative probabilities are:
p(Z_{{Ramon}}|{H})={0.63, 0.81, 0.55}
p(Z_{{Fluor}}|{H})={0.68, 0.72, 0.6}
p(Z_{{IR}}|{H})={0.55, 0.81, 0.63}
It is assumed that each of the reference data sets is equally likely, with:
p({H})={p(H_{A}), p(H_{B}), p(H_{C})}={0.33, 0.33, 0.33}
Applying Equation 4 results in:
p({H}|{Z})=α×{0.33, 0.33, 0.33}×[{0.63, 0.81, 0.55}·{0.68, 0.72, 0.6}·{0.55, 0.81, 0.63}]
p({H}|{Z})=α×{0.0779, 0.1591, 0.0687}
Now normalizing with α=1/(0.0779+0.1591+0.0687) results in:
p({H}|{Z})={0.25, 0.52, 0.22}
The search identifies the unknown sample as reference data set B, with an associated probability of 52%.

### Example 2

Raman and mid-infrared sublibraries each having reference data set for 61 substances were used. For each of the 61 substances, the Raman and mid-infrared sublibraries were searched using the Euclidean distance vector comparison. In other words, each substance is used sequentially as a target vector. The resulting set of scores for each sublibrary were converted to a set of probability values by first converting the score to a Z value and then looking up the probability from a Normal Distribution probability table. The process was repeated for each spectroscopic technique for each substance and the resulting probabilities were calculated. The set of final probability values was obtained by multiplying the two sets of probability values.

The results are displayed in Table 1. Based on the calculated probabilities, the top match (the score with the highest probability) was determined for each spectroscopic technique individually and for the combined probabilities. A value of “1” indicates that the target vector successfully found itself while a value of “0” indicates that the target vector found some match other than itself as the top match. The Raman probabilities resulted in four incorrect results, the mid-infrared probabilities resulted in two incorrect results, and the combined probabilities resulted in no incorrect results.

The more significant result is the fact that the distance between the top match and the second match is significantly large for the combined approach as opposed to Raman or mid-infrared for almost all of the 61 substances. In fact, 15 of the combined results have a difference that is a four times greater distance than the distance for either MIR or Raman, individually. Only five of the 61 substances do not benefit from the fusion algorithm.

| | | | | | Raman | MIR | Combined |
|---|---|---|---|---|---|---|---|
| Index | Substance | Raman | MIR | Combined | Distance | Distance | Distance |
| 1 | 2-Propanol | 1 | 1 | 1 | 0.0429 | 0.0073 | 0.0535 |
| 2 | Acetamidophenol | 1 | 1 | 1 | 0.0406 | 0.0151 | 0.2864 |
| 3 | Acetone | 1 | 1 | 1 | 0.0805 | 0.0130 | 0.2294 |
| 4 | Acetonitrile | 1 | 1 | 1 | 0.0889 | 0.0167 | 0.4087 |
| 5 | Acetylsalicylic Acid | 1 | 1 | 1 | 0.0152 | 0.0152 | 0.0301 |
| 6 | Ammonium Nitrate | 0 | 1 | 1 | 0.0000 | 0.0467 | 0.0683 |
| 7 | Benzalkonium Chloride | 1 | 1 | 1 | 0.0358 | 0.0511 | 0.1070 |
| 8 | Caffeine | 1 | 1 | 1 | 0.0567 | 0.0356 | 0.1852 |
| 9 | Calcium Carbonate | 1 | 1 | 1 | 0.0001 | 0.0046 | 0.0047 |
| 10 | Calcium chloride | 1 | 1 | 1 | 0.0187 | 0.0076 | 0.2716 |
| 11 | Calcium Hydroxide | 1 | 1 | 1 | 0.0009 | 0.0006 | 0.0015 |
| 12 | Calcium Oxide | 1 | 1 | 1 | 0.0016 | 0.0848 | 0.1172 |
| 13 | Calcium Sulfate | 0 | 1 | 1 | 0.0000 | 0.0078 | 0.2818 |
| 14 | Cane Sugar | 1 | 1 | 1 | 0.0133 | 0.0006 | 0.0137 |
| 15 | Charcoal | 1 | 1 | 1 | 0.0474 | 0.0408 | 0.1252 |
| 16 | Cocaine_pure | 1 | 1 | 1 | 0.0791 | 0.0739 | 0.2261 |
| 17 | Creatine | 1 | 1 | 1 | 0.1102 | 0.0331 | 0.3751 |
| 18 | D-Fructose | 1 | 1 | 1 | 0.0708 | 0.0536 | 0.1336 |
| 19 | D-Amphetamine | 1 | 0 | 1 | 0.0400 | 0.0000 | 0.0400 |
| 20 | Dextromethorphan | 1 | 1 | 1 | 0.0269 | 0.1067 | 0.2940 |
| 21 | Dimethyl Sulfoxide | 1 | 1 | 1 | 0.0069 | 0.0466 | 0.1323 |
| 22 | D-Ribose | 1 | 1 | 1 | 0.0550 | 0.0390 | 0.1314 |
| 23 | D-Xylose | 1 | 1 | 1 | 0.0499 | 0.0296 | 0.1193 |
| 24 | Ephedrine | 1 | 1 | 1 | 0.0367 | 0.0567 | 0.2067 |
| 25 | Ethanol_processed | 1 | 1 | 1 | 0.0269 | 0.0276 | 0.1574 |
| 26 | Ethylene Glycol | 1 | 1 | 1 | 0.1020 | 0.0165 | 0.1692 |
| 27 | Ethylenediamine- | 1 | 1 | 1 | 0.0543 | 0.0312 | 0.2108 |
| | tetraacetate | | | | | | |
| 28 | Formula 409 | 1 | 1 | 1 | 0.0237 | 0.0063 | 0.0663 |
| 29 | Glycerol GR | 1 | 1 | 1 | 0.0209 | 0.0257 | 0.1226 |
| 30 | Heroin | 1 | 1 | 1 | 0.0444 | 0.0241 | 0.2367 |
| 31 | Ibuprofen | 1 | 1 | 1 | 0.0716 | 0.0452 | 0.2785 |
| 32 | Ketamine | 1 | 1 | 1 | 0.0753 | 0.0385 | 0.2954 |
| 33 | Lactose Monohydrate | 1 | 1 | 1 | 0.0021 | 0.0081 | 0.0098 |
| 34 | Lactose | 1 | 1 | 1 | 0.0021 | 0.0074 | 0.0092 |
| 35 | L-Amphetamine | 1 | 0 | 1 | 0.0217 | 0.0000 | 0.0217 |
| 36 | Lidocaine | 1 | 1 | 1 | 0.0379 | 0.0418 | 0.3417 |
| 37 | Mannitol | 1 | 1 | 1 | 0.0414 | 0.0361 | 0.0751 |
| 38 | Methanol | 1 | 1 | 1 | 0.0996 | 0.0280 | 0.1683 |
| 39 | Methcathinone-HCl | 1 | 1 | 1 | 0.0267 | 0.0147 | 0.0984 |
| 40 | Para-methoxymethyl- | 1 | 1 | 1 | 0.0521 | 0.0106 | 0.0689 |
| | amphetamine | | | | | | |
| 41 | Phenobarbital | 1 | 1 | 1 | 0.0318 | 0.0573 | 0.1807 |
| 42 | Polyethylene Glycol | 1 | 1 | 1 | 0.0197 | 0.0018 | 0.1700 |
| 43 | Potassium Nitrate | 0 | 1 | 1 | 0.0000 | 0.0029 | 0.0125 |
| 44 | Quinine | 1 | 1 | 1 | 0.0948 | 0.0563 | 0.2145 |
| 45 | Salicylic Acid | 1 | 1 | 1 | 0.0085 | 0.0327 | 0.2111 |
| 46 | Sildenfil | 1 | 1 | 1 | 0.1049 | 0.0277 | 0.1406 |
| 47 | Sodium Borate | 1 | 1 | 1 | 0.0054 | 0.0568 | 0.0618 |
| | Decahydrate | | | | | | |
| 48 | Sodium Carbonate | 1 | 1 | 1 | 0.0001 | 0.0772 | 0.0915 |
| 49 | Sodium Sulfate | 1 | 1 | 1 | 0.0354 | 0.0023 | 0.3190 |
| 50 | Sodium Sulfite | 1 | 1 | 1 | 0.0129 | 0.0001 | 0.3655 |
| 51 | Sorbitol | 1 | 1 | 1 | 0.0550 | 0.0449 | 0.1178 |
| 52 | Splenda Sugar | 1 | 1 | 1 | 0.0057 | 0.0039 | 0.0093 |
| | Substitute | | | | | | |
| 53 | Strychnine | 1 | 1 | 1 | 0.0710 | 0.0660 | 0.2669 |
| 54 | Styrofoam | 1 | 1 | 1 | 0.0057 | 0.0036 | 0.0453 |
| 55 | Sucrose | 1 | 1 | 1 | 0.0125 | 0.0005 | 0.0128 |
| 56 | Sulfanilamide | 1 | 1 | 1 | 0.0547 | 0.0791 | 0.1330 |
| 57 | Sweet N Low | 1 | 1 | 1 | 0.0072 | 0.0080 | 0.0145 |
| 58 | Talc | 0 | 1 | 1 | 0.0000 | 0.0001 | 0.5381 |
| 59 | Tannic Acid | 1 | 1 | 1 | 0.0347 | 0.0659 | 0.0982 |
| 60 | Tide detergent | 1 | 1 | 1 | 0.0757 | 0.0078 | 0.2586 |
| 61 | Urea | 1 | 1 | 1 | 0.0001 | 0.0843 | 0.1892 |

The present disclosure may be embodied in other specific forms without departing from the spirit or essential attributes of the disclosure. Accordingly, reference should be made to the appended claims, rather than the foregoing specification, as indicating the scope of the disclosure. Although the foregoing description is directed to the embodiments of the disclosure, it is noted that other variations and modification will be apparent to those skilled in the art, and may be made without departing from the spirit or scope of the disclosure.

What is claimed is:

1. A method comprising:
providing a library having a plurality of sublibraries, wherein each sublibrary contains a plurality of reference data sets generated by a corresponding one of a plurality of spectroscopic data generating instruments associated with the sublibrary, and wherein each reference data set characterizes a corresponding known material;
obtaining a plurality of test data sets characteristic of an unknown material, wherein each test data set is generated by at least two different of the plurality of spectroscopic data generating instruments;
for each test data set, searching each sublibrary associated with the spectroscopic data generating instrument used to generate said test data set, to thereby produce a corresponding set of scores for each searched sublibrary, wherein each score in said set of scores indicates a likelihood of a match between a corresponding one of said plurality of reference data sets in said searched sublibrary and said test data set;
calculating a set of relative probability values for each searched sublibrary based on the corresponding set of scores for each searched sublibrary;
fusing all relative probability values for each searched sublibrary to thereby produce a set of final probability values to be used in determining whether said unknown material is represented through a corresponding known material characterized in the library.

2. The method of claim 1, said searching each sublibrary further comprising:
using a similarity metric that compares the test data set to each of the reference data sets in each of the searched sublibraries.

3. The method of claim 1, wherein each set of scores includes a score for each reference data set in the searched sublibrary.

4. The method of claim 1, wherein each set of relative probability values contains a plurality of relative probability values and each reference data set has a relative probability value.

5. The method of claim 1, further comprising:
selecting a highest final probability value from the set of final probability values;
comparing a minimum confidence value to the highest final probability value; and
reporting the known material represented in the library having the highest final probability value, if the highest final probability value is greater than or equal to the minimum confidence value.

6. The method of claim 1, further comprising applying a weighting factor to each set of relative probability values, to thereby produce a set of weighted probability values for each searched sublibrary.

7. The method of claim 1, wherein the weighting factor for each spectroscopic data generating instrument is the same.

8. The method of claim 1, wherein each spectroscopic data generating instrument has an associated weighting factor.

9. The method of claim 1, further comprising:
using a mean score based on a set of scores for an incomplete sublibrary, said incomplete sublibrary having fewer reference data sets than a number of the known materials.

10. The method of claim 1, wherein if one or more of the test data sets fails to match any reference data set in the searched sublibrary,
correcting one or more of the test data sets using order correction algorithms ranging from a zero-order correction to a first-order correction.

11. The method of claim 1, further comprising:
correcting one or more of the test data sets to remove signals and information not generated by a chemical composition of the unknown material.

12. The method of claim 1, further comprising:
detecting one or more of the test data sets having signals and information not generated by a chemical composition of the unknown material; and
issuing a warning to a user.

13. The method of claim 1, further comprising:
correcting one or more of the test data sets to remove a background test data set.

14. The method of claim 1, wherein said spectroscopic data generating instrument comprises one or more of the following a Raman spectrometer, a mid-infrared spectrometer, an x-ray diffractometer, an energy dispersive x-ray analyzer and a mass spectrometer.

15. The method of claim 1, wherein said reference data set comprises one or more of the following a Raman spectrum, a mid-infrared spectrum, an x-ray diffraction pattern, an energy dispersive x-ray spectrum, and a mass spectrum.

16. The method of claim 1, wherein said test data set comprises one or more of the following a Raman spectrum characteristic of the unknown material, a mid-infrared spectrum characteristic of the Unknown material, an x-ray diffraction pattern characteristic of the unknown material, an energy dispersive x-ray spectrum characteristic of the unknown material, and a mass spectrum characteristic of the unknown material.

17. The method of claim 1, further comprising:
providing a text description of each known material represented in the plurality of sublibraries;
individually searching each sublibrary, using a text query, that compares the text query to the text description of each known material to thereby produce a match answer or no match answer for each known material; and
removing the reference data set, from each sublibrary, for each known material producing the no match answer.

18. The method of claim 15, further comprising a physical property reference data set, said physical property reference data set selected from the group consisting of boiling point, melting point, density, freezing point, solubility, refractive index, specific gravity or molecular weight.

19. The method of claim 16, further comprising further comprising a physical property test data set, said physical property test data set selected from the group consisting of boiling point, melting point, density, freezing point, solubility, refractive index, specific gravity or molecular weight.

20. The method of claim 2, further comprising any similarity metric that will generate a score.

21. The method of claim 20, wherein said similarity metric comprises one or more of the following: an Euclidean distance metric, a spectral angle mapper metric, a spectral information divergence metric, and a Mahalanobis distance metric.

22. The method of claim 1, further comprising:
providing an image sublibrary containing a plurality of reference images generated by an image generating instrument associated with said image sublibrary, and
wherein each reference image characterizes a corresponding known material;
obtaining an image test data set characterizing an unknown material, wherein the image test data set is generated by said image generating instrument;
comparing the image test data set to the plurality of reference images.

23. The method of claim 1, further comprising:
enabling a user to view a first spectrum associated with a first reference data set generated by a first spectroscopic data generating instrument despite absence of a corresponding test data set from said first spectroscopic data generating instrument, wherein said unknown material is represented through a corresponding known material characterized by said first reference data set.

24. The method of claim 1, further comprising:
further enabling said user to view one or more additional spectra generated by said first spectrographic data generating instrument and closely matching said first spectrum despite absence of test data from said first spectroscopic data generating instrument corresponding to the reference data sets associated with said one or more additional spectra.

25. The method of claim 1, wherein if a highest final probability value is less than a minimum confidence value,
obtaining a plurality of second test data sets characteristic of the unknown material wherein each second test data set is generated by one of the plurality of the different spectroscopic data generating instruments;
combining the plurality of second test data sets with the plurality test data sets, such that the plurality of second test data sets and plurality of test data sets were generated by the same spectroscopic data generating instrument, to generate a plurality of combined test data sets,
for each combined test data set, searching each sublibrary associated with the spectroscopic data generating instrument used to generate the combined test data set, to thereby produce a corresponding second set of scores for each second searched sublibrary, wherein each second score in said second set of scores indicates a second likelihood of a match between a corresponding one of said plurality of reference data sets in said second searched sublibrary and each combined test data set;
calculating a second set of relative probability values for each searched sublibrary based on the corresponding second set of scores for each searched sublibrary;
fusing all second relative probability values for each searched sublibrary to thereby produce a second set of final probability values to be used in determining whether said unknown material is represented through a corresponding set of known materials in the library.

26. The method of claim 25, further comprising:
selecting a set of high second final probability values from the set of second final probabilities values;
comparing the minimum confidence value to the set of high second final probability values; and
reporting the set of known materials represented in the library having the high second final probability values, if each high second final probability value is greater than or equal to the minimum confidence value.

27. The method of claim 26 further comprising:
applying a spectral unmixing algorithm to the plurality of combined test data sets, to thereby produce residual test data sets associated with each searched sublibrary.

28. The method of claim 27 further comprising:
applying a multivariate curve resolution algorithm to the residual test data sets associated with each searched sublibrary to thereby generate a residual test spectra associated with each searched sublibrary; and
determining the identity of the unknown compound from the residual test spectra.

29. A method comprising:
providing a library having a plurality of sublibraries, wherein each sublibrary contains a plurality of reference data sets generated by a corresponding one of a plurality of spectroscopic data generating instruments associated with the sublibrary, and wherein each reference data set characterizes a corresponding known material;
obtaining a plurality of test data sets characteristic of an unknown material, wherein each test data set is generated by one or more of the plurality of spectroscopic data generating instruments,
for each test data set, searching each sublibrary associated with the spectroscopic data generating instrument used to generate said test data set, to thereby produce a corresponding set of scores for each searched sublibrary, wherein each score in said set of scores indicates a likelihood of a match between a corresponding one of said plurality of reference data sets in said searched sublibrary and said test data set;
calculating a set of relative probability values for each searched sublibrary based on the corresponding set of scores for each searched sublibrary;
fusing all relative probability values for each searched sublibrary to thereby produce a set of final probability values to be used in determining whether said unknown material is represented through a corresponding known material in the library.

30. The method of claim 29, said searching each sublibrary further comprising:
using a similarity metric that compares the test data set to each of the reference data Sets in each of the searched sublibraries.

31. The method of claim 29, wherein each set of scores includes a score for each reference data set in the searched sublibrary.

32. The method of claim 29, wherein each set of relative probability values contains a plurality of relative probability values and each reference data set has a relative probability value.

33. The method of claim 29, further comprising:
selecting a highest final probability value from the set of final probability values;
comparing a minimum confidence value to the highest final probability value; and
reporting the known material represented in the library having the highest final probability value, if the highest final probability value is greater than or equal to the minimum confidence value.

34. The method of claim 29, further comprising applying a weighting factor to each set of relative probability values, to thereby produce a set of weighted probability values for each searched sublibrary.

35. The method of claim 34, wherein the weighting factor for each spectroscopic data generating instrument is the same.

36. The method of claim 34, wherein each spectroscopic data generating instrument has associated weighting factor.

37. The method of claim 29, further comprising:
using a mean score based on a set of scores for an incomplete sublibrary, said incomplete sublibrary having fewer reference data sets than a number of the known materials.

38. The method of claim 29, wherein if one or more of the test data sets fails to match any reference data set in the searched sublibrary associated with the one or more test data sets,
correcting a one or more of the test data sets using order correction algorithms ranging from a zero-order correction to a first-order correction.

39. The method of claim 29, further comprising:
correcting one or more of the test data sets to remove signals and information not generated by a chemical composition of the unknown material.

40. The method of claim 29, further comprising:
detecting one or more of the test data sets having signals and information not generated by a chemical composition of the unknown material; and
issuing a warning to a user.

41. The method of claim 29, further comprising:
correcting one or more of the test data sets to remove a background test data set.

42. The method of claim 29, wherein said spectroscopic data generating instrument comprises one or more of the following a Raman spectrometer, a mid-infrared spectrometer, an x-ray diffractometer, an energy dispersive x-ray analyzer and a mass⁻spectrometer.

43. The method of claim 29, wherein said reference data set comprises one or more of the following a Raman spectrum, a mid-infrared spectrum, an x-ray diffraction pattern, an energy dispersive x-ray spectrum, and a mass spectrum.

44. The method of claim 29, wherein said test data set comprises one or more of the following a Raman spectrum characteristic of the unknown material, a mid-infrared spectrum characteristic of the unknown material, an x-ray diffraction pattern characteristic of the unknown material, an energy dispersive x-ray spectrum characteristic of the unknown material, and a mass spectrum characteristic of the unknown material.

45. The method of claim 29, further comprising:
providing a text description of each known material represented in the plurality of sublibraries;
individually searching each sublibrary, using a text query, that compares the text query to the text description of each known material to thereby produce a match answer or no match answer for each known material; and
removing the reference data set, from each sublibrary, for each known material producing the no match answer.

46. The Method of claim 43, further comprising a physical property reference data set, said physical property reference data set selected from the group consisting of boiling point, melting point, density, freezing point, solubility, refractive index, specific gravity or molecular weight.

47. The method of claim 44, further comprising further comprising a physical property test data set, said physical property test data set selected from the group consisting of boiling point, melting point, density, freezing point, solubility, refractive index, specific gravity or molecular weight.

48. The method of claim 30, further comprising any similarity metric that will generate a score.

49. The method of claim 48, wherein said similarity metric comprises one or more of the following: an Euclidean distance metric, a spectral angle mapper metric, a spectral information divergence metric, and a Mahalanobis distance metric.

50. The method of claim 30, further comprising:
providing an image sublibrary containing a plurality of reference images generated by an image generating instrument associated with said image sublibrary, and
wherein each reference image characterizes a corresponding known material;
obtaining an image test data set characterizing an unknown material, wherein the image test data set is generated by said image generating instrument;

51. The method of claim 29, wherein if a highest final probability value is less than a minimum confidence value,
obtaining a plurality of second test data sets characteristic of the unknown material wherein each second test data set is generated by one of the plurality of different spectroscopic data generating instruments;
combining the plurality of second test data sets with the plurality test data sets, such that the plurality of second test data sets and plurality of test data sets were generated by the same spectroscopic data generating instrument, to generate a plurality of combined test data sets,
for each combined test data set, searching each sublibrary associated with the spectroscopic data generating instrument used to generate the combined test data set, to thereby produce a corresponding second set of scores for each second searched sublibrary, wherein each second score in said second set of scores indicates a second likelihood of a match between a corresponding one of said plurality of reference data sets in said second searched sublibrary and each combined test data set;
calculating a second set of relative probability values for each searched sublibrary based on the corresponding second set of scores for each searched sublibrary;
fusing all second relative probability values for each searched sublibrary to thereby produce a second set of final probability values to be used in determining whether said unknown material is represented through a corresponding set of known materials in the library.

52. The method of claim 51, further comprising:
selecting a set of high second final probability values from the set of second final probabilities values;
comparing the minimum confidence value to the set of high second final probability values; and
reporting the set of known materials represented in the library having the high second final probability values, if each high second final probability value is greater than or equal to the minimum confidence value.

53. The method of claim 52, further comprising:
selecting a set of high second final probability values from the set of second final probabilities values;
comparing the minimum confidence value to the set of high second final probability values; and
reporting the set of known materials represented in the library having the high second final probability values, if each high second final probability value is greater than or equal to the minimum confidence value.

54. The method of claim 52 further comprising:
applying a linear spectral unmixing algorithm to the plurality of second test data sets, to thereby produce a plurality of residual data associated with each second searched sublibrary.

55. The method of claim 54 further comprising:
applying a multivariate curve resolution algorithm to the residual data associated with each second searched sublibrary to thereby generate a plurality of residual test data sets associated with each second searched sublibrary; and
determining the identity of the unknown compound from the residual test data sets.

56. A method comprising:
providing a library having a plurality of sublibraries, wherein each sublibrary contains a plurality of reference data sets generated by a corresponding one of a plurality of spectroscopic data generating instruments associated with the sublibrary, and wherein each reference data set characterizes a corresponding known material, wherein one sublibrary comprises an image sublibrary containing a set of reference feature data, wherein each said set of reference feature data includes one or more of the following: particle size, color value, and morphology data;
obtaining a plurality of test data sets characteristic of an unknown material, wherein each test data set is generated by one of the plurality of spectroscopic data generating instruments and one test data set comprises an image test data set generated by an image generating instrument extracting a set of test feature data from the image test data set, using a feature extraction algorithm, said test feature data comprising one or more of the following: particle size, color value, and morphology;
for said test feature data, searching said image sublibrary to compare each set of reference feature data with said set of test feature data to thereby produce a set of scores, wherein each score in said set of scores indicates a likelihood of a match between a corresponding set of reference feature data in said searched image sublibrary and said set of test feature data;
for each test data set, searching each sublibrary associated with the spectroscopic data generating instrument used to generate said test data set, to thereby produce a corresponding set of scores for each searched sublibrary, wherein each score in said set of scores indicates a likelihood of a match between a corresponding one of said plurality of reference data sets in said searched sublibrary and said test data set;
calculating a set of relative probability values for each searched sublibrary based on the corresponding set of scores for each searched sublibrary and a set of relative probability values for the image sublibrary based on the corresponding set of scores for the image sublibrary;
fusing all relative probability values for each searched sublibrary and search image sublibrary to thereby produce a set of final probability values to be used in determining whether said unknown material is represented through a corresponding known material characterized in the library;
reporting the known material represented in the library having the highest final probability value, if the highest final probability value is greater than or equal to the minimum confidence value.

57. A system comprising:
a library having a plurality of sublibraries, wherein each sublibrary contains a plurality of reference data sets generated by a corresponding one of a plurality of spectroscopic data generating instruments associated with the sublibrary, and wherein each reference data set characterizes a corresponding known material;
a plurality of spectroscopic data generating instruments;
a plurality of test data sets characteristic of an unknown material, wherein each test data set is generated by one or more of the plurality of spectroscopic data generating instruments,
a processor for:
searching each sublibrary associated with the spectroscopic data generating instrument used to generate said test data set, to thereby produce a corresponding set of scores for each searched sublibrary, wherein each score in said set of scores indicates a likelihood of a match between a corresponding one of said plurality of reference data sets in said starched, sublibrary and said test data set;
calculating a set of relative probability values for each searched sublibrary based on the corresponding set of scores for each searched sublibrary; and
fusing all relative probability values for each searched sublibrary to thereby produce a set of final probability values to be used in determining whether said unknown material is represented through a corresponding known material characterized in the library.
